(19) United States
(12) Patent Application Publication
(10) Pub. No.: US 2025/0253970 A1
(43) Pub. Date: Aug. 7, 2025

(54) COVERAGE EXTENSION AND RELIABILITY ENHANCEMENT FOR REDUCED CAPABILITY DEVICES

(71) Applicant: T-Mobile Innovations LLC, Overland Park, KS (US)

(72) Inventor: Mochamad MIRZA, Bothell, WA (US)

(21) Appl. No.: 18/433,694

(22) Filed: Feb. 6, 2024

(51) Int. Cl. H04L 1/00

(52) U.S. Cl. CPC H04L 1/0003; H04L 1/0026

(57) ABSTRACT

Methods provided herein include extending coverage for a group of devices. The method includes maintaining a default block error rate (BLER) target and lowering the default BLER target to an adjusted BLER target for a specific device type. The method further includes applying the adjusted BLER target to the specific device type, thereby extending coverage for the specific device type. The method further includes generating and transmitting new information elements to extend coverage and allow access for the specific type.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Within the above-described networks, the wireless device class including internet of things (IoT) devices has experienced rapid growth. While the number of smartphones is tied to the number of subscribers, IoT devices are not similarly limited. Various IoT devices were developed for use with 4G LTE networks and these developments have expanded for 5G networks. IoT devices build the network of physical objects or things that are embedded with sensors, software, and other technologies for the purpose of connecting and exchanging data with other devices and systems over the Internet. Cellular IoT is a way of connecting physical things, such as sensors to the internet by having them utilize the same mobile networks as wireless devices. In the consumer market, IoT technology is frequently utilized to equip the “smart home”, including devices such as lighting fixtures, thermostats, home security systems and cameras. The devices can often be controlled using smartphones. Further, businesses, such as utility companies utilize industrial wireless sensors for reporting usage parameters and performing other necessary tasks.

For various reasons, including, for example, excessive cost and complexity, existing devices utilized with 4G LTE networks have not always been suited to the newer 5G NR networks. Accordingly, in 5G NR Release 17, 3GPP introduced reduced capability (RedCap) devices. RedCap devices generally have reduced complexity and lower power consumption than other IoT devices due to design optimization. Whereas 5G enhanced mobile broadband (eMBB) devices support gigabits per second of throughput in both downlink and uplink, the ReCap devices support a reduced throughput of, for example 150 Mbps in the downlink and 50 Mbps in the uplink, which is sufficient for various IoT use cases. While the RedCap devices can be contrasted with the eMBB devices in terms of throughput, these devices typically have greater throughput than previously available IoT devices used with 4G LTE networks. While 4G LTE networks are expected to coexist with 5G networks, the RedCap devices can offer a higher level of capability, efficiency, and flexibility. The RedCap devices offer higher throughput, lower latency, longer battery life, and stronger security than pre-existing IoT devices.

### Overview

Exemplary embodiments provided herein include a method for extending RedCap coverage while improving RedCap reliability. The coverage extension and reliability improvements are particularly useful for specific use cases, such as, for example, industrial wireless sensors. The method includes maintaining a default block error rate (BLER) target that applies generally throughout a network or throughout a segment of the network and lowering the default BLER target to an adjusted BLER target for a specific device type, such as the RedCap device type. The method further includes applying the adjusted BLER target to the specific device type, thereby extending coverage for the specific device type.

A further exemplary embodiment includes a system incorporating a memory storing data and instructions and a processor accessing the stored data and executing the stored instructions to perform multiple operations. The operations include providing a first block error rate (BLER) target for a first group of devices and providing a second BLER target for a second group of devices, wherein the second BLER target is lower than the first BLER target and the second group of devices includes reduced capability (RedCap) devices. The operations additionally include applying the second BLER target to the second group of devices to extend coverage for the second group of devices.

In yet a further exemplary embodiment, a method is provided including multiple steps. The steps include providing a first BLER target for a first group of devices including enhanced mobile broadband (eMBB) devices and providing a second BLER target for a second group of devices, wherein the second BLER target is lower than the first BLER target and the second group of devices includes RedCap devices. The method further includes applying the second BLER target to the second group of devices to extend coverage for the second group of devices.

Embodiments provided herein further include defining information elements (IEs) for cell access for the RedCap devices. The IEs include, for example, random access channel (RACH) and cell reselection IEs.

In yet additional embodiments, a non-transitory computer-readable mediums may store instructions executed by a processor to perform the operations described above. Further, a processing node performing the operations described herein may be utilized.

### BRIEF DESCRIPTION OF THE DRAWINGS

FIG. 1 depicts an exemplary environment for a coverage extension system in accordance with an embodiment.

FIG. 2 depicts an exemplary coverage extension system in accordance with an embodiment.

FIG. 3 depicts an exemplary access node in accordance with an embodiment.

FIG. 4 depicts an exemplary method in accordance with an embodiment.

FIG. 5 depicts a further exemplary method in accordance with an embodiment.

FIG. 6 depicts an additional exemplary method in accordance with an embodiment.

### DETAILED DESCRIPTION

Embodiments provided herein include a method for extending 5G Redcap coverage and improving its reliability. While 5G RedCap devices include a reduced number of antenna branches, there is no specific feature available to extend 5G RedCap coverage and improve its reliability. RedCap coverage and reliability are quite similar to eMBB smartphone coverage and reliability. However, for specific use cases, for example, industrial wireless sensors, which are often located in underground and difficult to reach locations, there is a need to extend coverage and improve reliability. Accordingly, methods provided herein lower a RedCap block error rate (BLER) target in a stored link adaptation algorithm and introduce new information elements (IEs) for RedCap cell access including random access channel (RACH) and cell reselection between 5G NR carriers.

Link adaptation is a technique used in wireless networks to determine the modulation and coding scheme used in signal transmission. The adjusted BLER target may be incorporated in a link adaptation algorithm. BLER can be defined as the ratio of the number of erroneous blocks received to the total number of blocks sent. Base stations or access nodes can estimate the BLER based on the acknowledgements (ACKs) and negative acknowledgements (NACKs) in a given period. The link adaptation algorithm can perform adjustments to the modulation and coding scheme (MCS) and the number of repetitions allowed based on conditions reported to the base station or access node by the wireless device.

In favorable channel conditions, a high-level efficient modulation scheme and a small amount of error correction may be used. This gives a high data throughput on the radio channel. For less optimal channel conditions, a low-level, more robust, modulation scheme is used and the amount of error correction is increased, causing data throughput to drop. The optimal modulation and coding scheme (MCS) for wireless transmission depends on the wireless channel state. Hence, wireless link adaptation relies on periodically reported channel quality index (CQI) values by the wireless device, for example through a sounding reference signal (SRS), to select the optimal MCS for each transmission instance. To optimize link performance for a given wireless environment, current link adaptation techniques rely on tuning parameters such as the BLER target. If BLER values go beyond this target, an access node or gNB can apply adjust MCS schemes for link adaptation.

Thus, service specific link adaptation can be used to extend RedCap coverage by lowering the BLER target for identified RedCap devices. In current implementations, the same BLER target applies to eMBB and RedCap devices. However, significant coverage extension can be achieved for RedCap devices by grouping the RedCap devices and selectively lowering the BLER target for the group. The BLER target may be an uplink BLER target or a downlink BLER target or may apply generally to both uplink and downlink communications. That is, the BLER target may be lowered only for uplink communications or for both uplink and downlink communications or for only downlink communications. For example, a default BLER target may be 10% and the lowered BLER target may be 2%. Optionally, depending on network particulars, the BLER target may be less than 2% and may be adjusted, for example, to between zero and one percent. In certain network environments, lowering the BLER target from 10% to 2% has been shown to increase coverage from about 123 dBM to 136 dBM.

Further, embodiments provided herein utilize an adjusted MCS table to further extend RedCap coverage. Additionally, embodiments provided herein introduce new information elements (IEs) to facilitate RedCap coverage extension. Optimally, by incorporating this innovation, RedCap devices are able to continue to function at a low signal strength with very poor coverage. Further, in embodiments provided herein, lowering of the number of layers, for example from two to one also improves coverage. This can be achieved, for example, through transmit diversity.

Accordingly, in embodiments provided herein, the BLER target for eMBB devices remains at the default value, e.g., 10%, which is higher than the BLER target for RedCap devices. While lowering the BLER target improves coverage, it results in a lower MCS which decreases spectral efficiency for the network. Because the throughput, and therefore, the amount of data transmitted between RedCap devices and the network is much lower than the throughput and amount of data transmitted between eMBB devices and the network, the reduced BLER target applied only to RedCap devices has minimal impact on the network efficiency.

While the above-described methods may extend coverage while RedCap devices are in connected mode, embodiments provided herein also ensure that RedCap devices are able to receive a signal while in idle mode. Accordingly, different access thresholds may be established for RedCap devices. The access thresholds, for example for reference signal received power (RSRP) can be transmitted to the RedCap devices through new information elements (IEs) transmitted to the RedCap devices from an access node.

Accordingly, embodiments provided herein extend RedCap coverage and reliability improvement by lowering RedCap BLER target in a link adaptation algorithm and introducing new IEs for RedCap cell access including RACH and cell reselection between NR carriers.

An exemplary system described herein includes at least an access node (or base station), such as an eNodeB, a next generation NodeB (gNodeB), and a plurality of end-user wireless devices. For illustrative purposes and simplicity, the disclosed technology will be illustrated and discussed as being implemented in the communications between an access node (e.g., a base station) and a wireless device (e.g., an end-user wireless device).

In addition to the systems and methods described herein, the operations for coverage extension may be implemented as computer-readable instructions or methods, and processing nodes on the network for executing the instructions or methods. The processing node may include a processor included in the access node or a processor included in any controller node in the wireless network that is coupled to the access node.

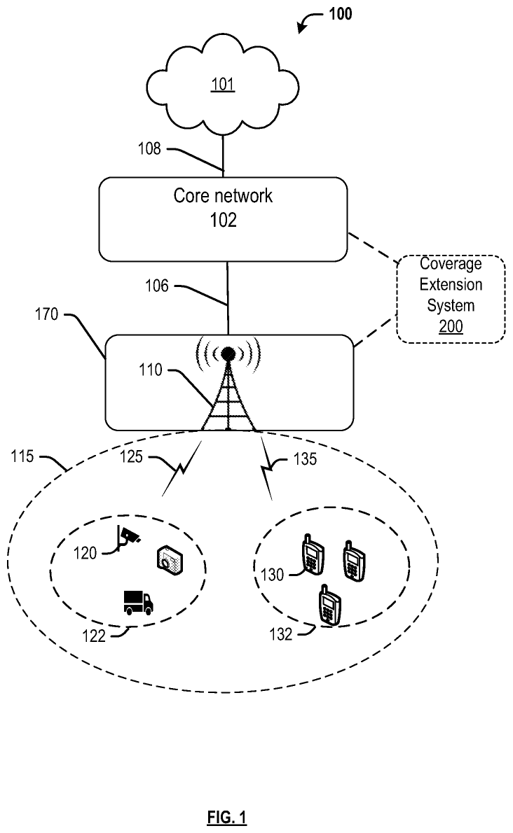

FIG. 1 depicts an exemplary environment 100 for coverage extension in a wireless network. In the displayed environment 100, a coverage extension system 200 operates to extend coverage for a selected type of wireless device 120, for example, RedCap devices. Accordingly, the coverage extension system 200 may operate on a group 122 containing wireless devices 120 and may not operate on a group 132 including wireless devices 130, which may, for example, be eMBB devices.

Environment 100 comprises a communication network 101, core network 102, and a radio access network (RAN) 170 including at least an access node 110. Wireless devices 120, 130 communicate with the access node 110. Further, a coverage extension system 200 operates to extend coverage and improve reliability for RedCap devices 120. Additionally, components not shown may include, for example, gateway node(s) controller nodes, and additional access nodes.

Access node 110 can be any network node configured to provide communication between end-user wireless devices 120, 130 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 120, 130 are illustrated in FIG. 1, any number of access nodes and wireless devices can be implemented within environment 100.

As further described herein, by utilizing antennas, access node 110 can deploy a wireless air interface using one or more frequency bands over one or more coverage areas 115. Higher frequency bands may result in smaller coverage areas and lower frequency bands may result in larger coverage areas. Further, the different sets of antennas can be used to implement various transmission modes or operating modes in each sector, including but not limited to MIMO (including SU-MIMO, MU-MIMO, mMIMO, beamforming, etc.), carrier aggregation (including inter-band and intra-band carrier aggregation), and different duplexing modes including FDD and TDD.

For example, as illustrated herein, some of the antennas of access node 110 can be allocated towards deploying a first carrier using wireless connection 125. Other antennas having a first frequency and other antennas of access node 110 can be allocated towards deploying a second carrier using a second frequency, to which wireless devices attach using wireless connection 135. Additionally, multiple access nodes may be provided, each deploying multiple antennas. Further, different carriers may utilize different modes or the same modes of operation include FDD or TDD modes of operation.

The exemplary operating environment 100 may further include coverage extension system 200, which is illustrated as operating between the core network 102 and the RAN 170. However, it should be noted that the coverage extension system 200 may operate in the core 102, in the RAN 170, or may be distributed. For example, the coverage extension system 200 may utilize components located at both the core network 102 and at the multiple access nodes 110. Alternatively, the coverage extension system 200 may be an entirely discrete system operating in conjunction with the RAN 170, core 102 and/or the wireless devices 120, 130.

The coverage extension system 200 receives information pertaining to wireless devices from wireless devices 120, 130. For example, the coverage extension system 200 may collect performance parameters, location information, capabilities, and identification information. In embodiments set forth herein, the wireless devices 120, 130 may send these parameters to the access nodes 110, which convey relevant parameters to the coverage extension system 200. The coverage extension system 200 analyzes this information in order to determine a grouping and ultimately a BLER target and a connectivity threshold for a wireless device. For example, the coverage extension system 200 may be configured to execute methods including grouping wireless devices and assigning a BLER target to each group. The groups may include, for example, at least one RedCap group 122 and at least one eMBB group 132.

Further, the access node 110 may receive channel state information from the wireless devices 120, 130 and may utilize a link adaptation algorithm of the coverage extension system 200 to achieve a target BLER based on the above-described grouping step. Thus, exemplary embodiments described herein include link adaptation for wireless devices to achieve a particular BLER target based on a grouping. For example, wireless devices grouped into the RedCap group 122 have a lower target BLER than wireless devices in the eMBB group 132. For example, the target BLER for the RedCap devices may be between zero and three percent and the target BLER for the eMBB devices may be between nine and eleven percent.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Further while the access node 110 and coverage extension system 200 may operate to group devices into a first RedCap group 122 and a second eMBB group 132 and determine a target BLER based on the grouping for connected devices, the coverage extension system 200 may also utilize the groupings to extend coverage for devices in idle mode. For example, the coverage extension system 200 may provide new IEs for the RedCap group 122 in order to extend coverage. By leveraging the groupings, the coverage extension system 200 can adapt to the dynamic nature of the wireless devices 120, 130 to provide more efficient and reliable communication services.

Further, the access node 110 may communicate with the coverage extension system 200 or alternatively may wholly or partially incorporate the coverage extension system 200. Thus, the coverage extension system 200 may collect data from the wireless devices 120, 130 and group the wireless devices 120, 130. Further, for wireless devices in a selected group that are in connected mode, the coverage extension system 200 may determine and apply a reduced BLER target. For wireless devices in the selected group that are not connected, e.g., wireless devices in idle mode, the coverage extension system 200 may transmit new information elements setting new connectivity thresholds to ensure that the wireless devices in the selected group can connect to the network.

Wireless devices 120, 130 may be any device, system, combination of devices, or other such communication platform capable of communicating wirelessly with access node 110 using one or more frequency bands deployed therefrom. Wireless devices 120 may be or include RedCap devices, which include IoT devices forming a network of physical objects or things that are embedded with sensors, software, and other technologies for the purpose of connecting and exchanging data with other devices and systems over the Internet. RedCap devices are aimed to lower cost and complexity. The RedCap devices have narrower bandwidths, i.e., 20 MHz in sub-7 GHz or 100 MHz in millimeter wave (mmWave) frequency bands, a single transmit antenna, a single receive antenna, with two receive antennas being optional. The RedCap devices further provide optional support for half-duplex FDD, lower-order modulation, with 256-QAM being optional, and support for lower transmit power. The RedCap devices may also be limited to one or two Rx branches with either one or two MIMO layers being supported, respectively. They also could have a maximum modulation order of 64 QAM rather than the 256 QAM for eMBB devices depending on factors including frequency range The reduced complexity contributes to cost savings, longer battery life due to lower power consumption, and a smaller device footprint, which enables newer designs for a broad range of use cases. Examples of use cases pertaining to RedCap include wearables such as smart watches, wearable medical devices, and low-end AR/VR glasses, video surveillance, industrial sensors, smart grids.

Wireless devices 130 may be, for example, eMBB devices. The devices may be or include, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110.

Subsequent to sending capabilities to the access node 110, for example, through a capability information message, the wireless devices 120, 130, may be grouped and may receive SIB messages if in idle mode or may be assigned a BLER target if in connected mode. SIB messages may be sent, for example, periodically throughout a communication session. Thus, wireless devices 120 in connected mode assigned to the RedCap group 122 may be assigned a reduced BLER target. Wireless devices 120 in idle mode assigned to the RedCap group 122 may receive SIB messages with an adjusted connectivity threshold to ensure that the wireless devices 120 in the RedCap group 122 are able to connect to the network.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 130 and is responsible for handling connection and mobility management tasks. The SMF is primarily responsible for creating, updating, and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 130, 140, etc. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path—including combinations thereof. Communication link 106 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications links 106 may include S1 communications links. Other wireless protocols can also be used. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

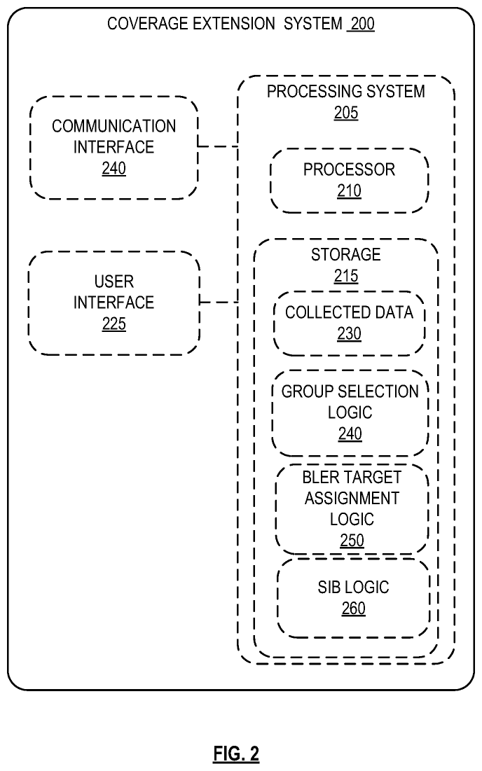

FIG. 2 illustrates a coverage extension system 200 in accordance with embodiments described herein. The components described herein are merely exemplary as many different configurations for the coverage extension system 200 may be implemented. The coverage extension system 200 may be configured to perform the methods and operations disclosed herein to extend coverage for a selected group of wireless devices. In the disclosed embodiments, the coverage extension system 200 may be integrated with each access node 110, integrated with the core network 102 or may be an entirely separate component capable of communicating with at least the wireless devices 120, 130 and the RAN 170. Further, the components of the coverage extension system 200 may be distributed so that one or more components is located at an access node 110 and one or more other components are located within a separate processing node or at the core network 102.

The coverage extension system 200 may be configured for collecting data transmitted by the wireless devices 120, 130 to the access nodes 110. To perform processes for coverage extension, the coverage extension system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, group selection logic 240 may store instructions to form groups of wireless devices based on collected data 230 and BLER target assignment logic 250 may be utilized to set and assign a BLER target for each group. Additionally, system information block (SIB) logic 260 may generate and assign IEs to be transmitted to the wireless devices 120, 130 based on group. Further, the memory 215 may store the collected data at 230, which may be or include data collected from the wireless devices 120, 130, from the RAN 170 or from the core network 102. To perform the above-described operations, the group selection logic 240 and BLER assignment logic 250, and SIB logic 260 may be executed by the processor 210 to operate on the collected data 230.

Processor 210 may be a microprocessor and may include hardware circuitry and/or embedded codes configured to retrieve and execute software stored in storage device 215. The coverage extension system 200 further includes a communication interface 220 and a user interface 225. Communication interface 220 may be configured to enable the processing system 205 to communicate with other components, nodes, or devices in the wireless network. For example, the coverage extension system 200 receives relevant parameters from an access node 110 or from the wireless devices 120, 130 or from the core network 102.

Communication interface 220 may include hardware components, such as network communication ports, devices, routers, wires, antenna, transceivers, etc. User interface 225 may be configured to allow a user to provide input to the coverage extension system 200 and receive data or information from access nodes 110 or the wireless devices 120, 130. User interface 225 may include hardware components, such as touch screens, buttons, displays, speakers, etc. The coverage extension system 200 may further include other components such as a power management unit, a control interface unit, etc.

The location of the coverage extension system 200 may depend upon the network architecture. As set forth above, the coverage extension system 200 may be located in an access node 110, in a separate processing node, in the RAN 170, in multiple locations, or may be an entirely discrete component. Further, although shown as a single integrated system, the functions of data collection, group selection, BLER assignment, and SIB assignment may be separated and disposed in separate locations.

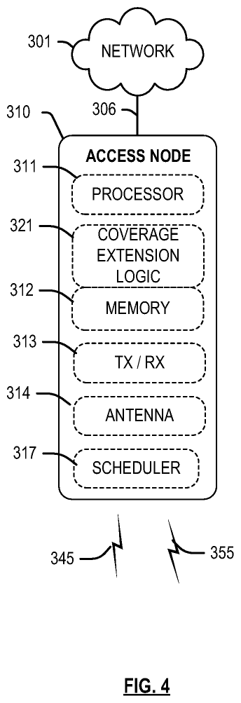

FIG. 3 depicts an exemplary access node 310. Access node 310 is configured as an access point for providing network services from network 301 to end-user wireless devices such as wireless devices 120, 130 in FIG. 1. Access node 310 is illustrated as comprising a memory 312 for storing logical modules that perform operations described herein, a processor 311 for executing the logical modules, and a transceiver 313 for transmitting and receiving signals via antennas 314. Combinations of antennas 314 and transceivers 313 are configured to deploy wireless air interfaces. Further, the different sets of antennas can be used to implement various transmission modes or operating modes in each sector, including but not limited to MIMO (including SU-MIMO, MU-MIMO, mMIMO, beamforming, etc.), CA, and different duplexing modes including FDD and TDD. Further, access node 310 is communicatively coupled to network 301 via communication interface 306, which may be any wired or wireless link as described above. Scheduler 317 may be provided for scheduling resources based on the presence and performance parameters of the UEs 120, 130. Wireless communication links 345 and 355 may facilitate communication with the wireless devices 120, 130 in both uplink and downlink directions.

In an exemplary embodiment, memory 312 includes coverage extension logic 321 for performing the functions identified above. For example, access node 310 may be configured to group connected wireless devices into eMBB and RedCap groups. The access node 310 may be further configured to assign a BLER target and SIB elements to the groups.

Further, as the access node 310 is described as performing the methods described herein, processing nodes, gateway nodes, or other nodes in the RAN 170 may employ methods disclosed to identify RedCap devices and form both a RedCap group and an eMBB group. The node may then adjust the target BLER and SIB messages as further described herein.

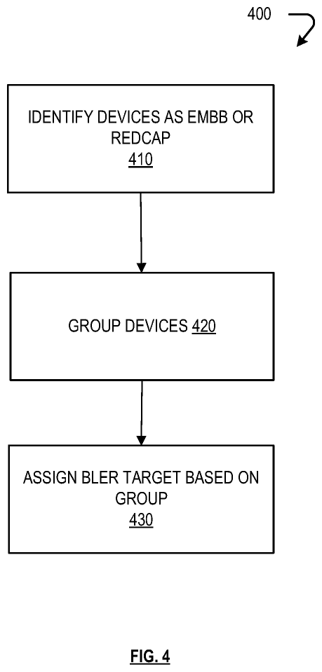

FIG. 4 illustrates an exemplary method 400 for dynamically extending coverage and improving reliability for selected types of wireless devices in a network. Method 400 may be performed by any suitable processor discussed herein, for example, a processor included in access node 110 or 310, or the processor 210 included in the coverage extension system 200. For discussion purposes, as an example, method 400 is described as being performed by the processor 210 included in the coverage extension system 200.

Method 400 starts in step 410, in which the processor 210 may identify devices in the network as eMBB or RedCap devices. These devices can be identified in various ways. In one embodiment, RedCap devices may self-identify to the network by utilizing key identifiers unique to a RedCap device at a lower layer, namely the media access control (MAC) layer. Accordingly, the RedCap devices would convey a RedCap specific identity in the form of a logical channel identifier (LCID). In so doing, the receiving access node 110 will be notified and act accordingly. As an alternative, the access node 110 may assign access parameters that are reserved specifically for RedCap devices. In utilizing these parameters, the RedCap device makes the access node 110 aware of its classification. Further, 3GPP Release 17 introduced an indication to determine during the random-access procedure, whether a wireless device has reduced capabilities compared to legacy devices.

In step 420, the processor 210 may group the wireless devices in the network. As set forth above, the wireless devices may be grouped based on identification as RedCap or eMBB devices. Thus, the processor 210 creates two groups of wireless devices. Thus, the processor 210 groups the wireless devices 120, 130 into the RedCap group 122 and the eMBB group 132.

In embodiments set forth herein, once the processor 210 groups the wireless devices 120, 130 into RedCap group 122 and eMBB group 132, the processor 210 may adjust the target BLER for connected devices in the RedCap group 122 in step 430. In some embodiments, the target BLER may be adjusted to any percentage between one percent and three percent. In other embodiments, the target BLER may be adjusted to less than one percent. In contrast, the processor 210 may not adjust the BLER target for the wireless devices 130 in the eMBB group 132. Additionally, while the BLER target is adjusted for only the RedCap group, a default BLER target may be applied to the eMBB group. In various embodiments, the default BLER is ten percent or alternatively may be between nine percent and eleven percent. Further, in some embodiments, the BLER target may be adjusted for the RedCap group in both uplink and downlink directions. In other embodiments, the BLER target may be adjusted for the RedCap devices in only one of the uplink and downlink directions.

The aforementioned BLER target adjustments positively impact performance for the RedCap devices by providing coverage extension and improved reliability. Further, the lowering of the BLER target for only RedCap devices has a minimal impact on overall network performance due to the relatively minimal throughput and data transfer between the RedCap devices and the network.

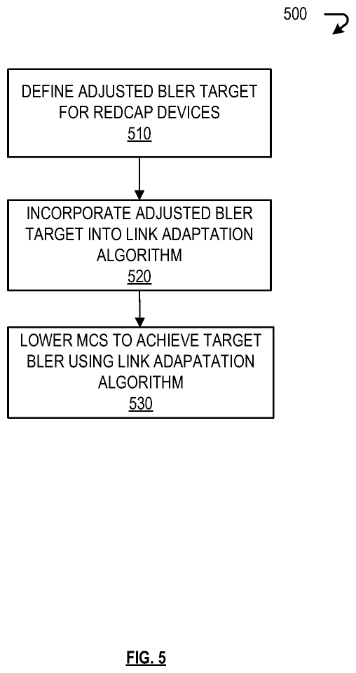

FIG. 5 depicts an exemplary method 500 for providing coverage extension for RedCap devices in accordance with embodiments described herein. Method 500 may be performed by any suitable processor discussed herein, for example, a processor included in access node 110 or 310, or the processor 210 in the coverage extension system 200. For discussion purposes, as an example, method 500 is described as being performed by a processor 210 included in the coverage extension system 200.

In step 510, the access node 410 may define an adjusted BLER target for RedCap devices. In embodiments described herein, the processor 210 defines the adjusted BLER target as below the default BLER target utilized within the network. The particular adjusted BLER target may be network specific, but may be, for example, between one and three percent. In particular embodiments, the BLER target for RedCap devices 120 may be adjusted to two percent.

In step 520, the processor 210 incorporates the adjusted BLER target in a link adaptation algorithm for the network. The link adaptation algorithm adjusts link characteristics based on conditions reported by wireless devices. Link adaptation in wireless networks is used to select the appropriate modulation and coding scheme to achieve the target BLER. In order to accomplish link adaptation, the wireless device reports channel state information to the access node to provide information regarding the state or conditions of the channel. The base station then uses the reported conditions in conjunction with the link adaptation algorithm to adjust the modulation and coding scheme (MCS) combination as well as a number of repetitions in order to achieve the target BLER.

Thus, in step 530, using the link adaptation algorithm, the processor 210 may cause the modulation and coding scheme (MCS) to be lowered to achieve coverage extension for the RedCap devices. The link adaptation finishes when reaching a target block error rate (BLER).

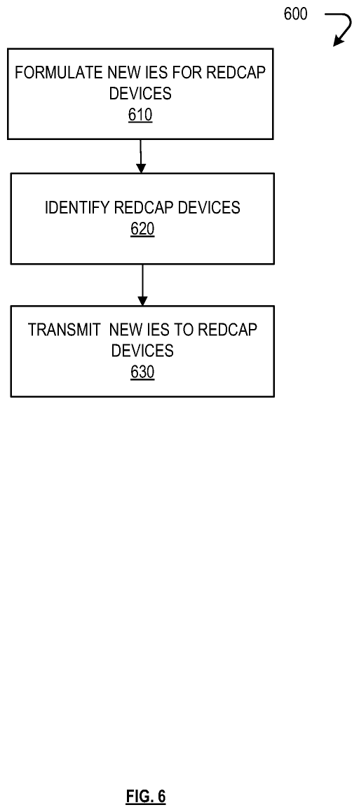

FIG. 6 illustrates a method 600 for coverage extension in accordance with embodiments described herein. Method 600 may be performed by any suitable processor discussed herein, for example, a processor included in access node 110 or 310 or the processor 210 included in the coverage extension system 200. For discussion purposes, as an example, method 600 is described as being performed by the processor 210 included in the coverage extension system 200.

In step 610, the processor 210 formulates new information elements (IEs) for RedCap devices. In particular, the new IEs include, for example, system information blocks (SIBs) including SIB1, SIB2, and SIB4. Whereas the adjusted BLER target described above may be applied to connected RedCap devices, the new IEs may be transmitted to idling RedCap devices or RedCap devices not currently connected to the network. Idle mode occurs when the UE has no radio resource control (RRC) connection attached to it. In this state, the wireless device can perform a number of activities such as PLMN selection, cell selection, cell reselection, or tracking area updates. The new IEs may set connectivity thresholds to ensure that the idling RedCap devices will be able to connect to the network in conditions during which eMBBs may not be able to connect. The new IEs may be created for random access channel (RACH) and cell reselection between NR carriers.

In step 620, the processor 210 identifies RedCap devices. The identification may occur in the manner described above. However, this step may be optional as the RedCap devices may alternatively self-identify within an RRC connection request or in response to a broadcast message. Further, the RedCap devices may be grouped as described herein.

Finally, in step 630, the processor 210 may trigger sending of the new IEs to the RedCap devices from the access node 110. The new IEs are transmitted to wireless devices attempting to access the network or sitting in idle mode within the network. In embodiments set forth herein, the IEs may be contained in broadcast messages or may be transmitted responsive to RRC connection requests from the wireless devices. The new IEs may include, for example, a new IE for SIB1 cell access. For example, the following IE may be utilized:

$$\begin{matrix}cellSelectionInfo - q\_RxLevMin \_redCap \_r17 \\ cellSelectionInfo - q\_RxLevMinOffset \_redCap \_r17\end{matrix} \qquad ( 1 )$$

Wireless devices select a cell using measured reference signal received power (RSRP) and may calculate reference signal received quality (RSRQ). The wireless device may filter through these thresholds. For example, q_RxLevMin_redCap_r17 sets a minimum threshold for RSRP for RedCap devices to access a cell. The parameter q_RxLevMinOffset_redCap_r17 may be used to further restrict or ease access to a particular cell. These parameters establish the minimum RSRP the RedCap device has to measure from a particular cell in order to connect. This new information element provides the ability for RedCap devices to connect to a cell after measuring an RSRP below the threshold provided for eMBB devices. Accordingly, while the pre-existing information elements provide an RSRP threshold, the new RedCap information element provides a lower RSRP threshold. Thus, as a specific use case, an underground industrial sensor may connect to a cell to transmit a measurement despite an RSRP measurement too low for most wireless functionality.

Further, a new IE may be utilized for SIB1 RACH configuration as follows:

$$\begin{matrix}prach\_ConfigurationIndex \_redCap \_r17 \\ msg1\_FDM \_redCap \_r17 \\ msg1\_FrequencyStart = 2 \\ preambleReceivedTargetPower\_redCap \_r17 \\ preambleTransMax\_redCap \_r17 \\ powerRampingStep\_redCap \_r17 \\ ra\_ResponseWindow \_redCap \_r17 \\ ra\_ContentionResolutionTimer \_redCap \_r17\end{matrix} \qquad ( 2 )$$

Additionally, a new IE may be utilized for SIB2 intra-frequency and serving reselection: (3) intraFreqCellReselectionInfo—q_RxLevMin_redCap_r17. Finally, a new IE, SIB4 may be provided for inter-frequency cell selection. For example, the new SIB4 IE may be: (4) interFreqCarrierFreqList—q_RxLevMin_redCap_r17. These IEs also set lower RSRP thresholds for connectivity, thus allowing RedCap devices to connect to a cell or select a channel based on a lower RSRP threshold than eMBB devices.

In some embodiments, methods 400, 500, and 600 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, and 600 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
maintaining a default block error rate (BLER) target;
lowering the default BLER target to an adjusted BLER target for a specific device type; and
applying the adjusted BLER target to the specific device type, thereby extending coverage for the specific device type.

2. The method of claim 1, further comprising providing the adjusted BLER target for uplink BLER.

3. The method of claim 1, further comprising providing the adjusted BLER target for both downlink and uplink BLER.

4. The method of claim 1, further comprising applying the default BLER target to enhanced mobile broadband (eMBB) devices.

5. The method of claim 1, further comprising using a particular modulation coding scheme (MCS) table to further extend coverage for the specific device type.

6. The method of claim 1, wherein the specific device type is a reduced capability (RedCap) device.

7. The method of claim 1, wherein the default BLER target is 10% and the adjusted BLER target is 2%.

8. The method of claim 1, further comprising creating information elements (IEs) for cell access for the specific device type.

9. The method of claim 8, further comprising creating IEs for random access channel (RACH) and cell reselection between new radio (NR) carriers.

10. A system comprising:
a memory storing data and instructions; and
a processor accessing the stored data and executing the stored instructions to perform operations including;
providing a first block error rate (BLER) target for a first group of devices;
providing a second BLER target for a second group of devices, wherein the second BLER target is lower than the first BLER target and the second group of devices includes reduced capability (RedCap) devices; and
applying the second BLER target to the second group of devices to extend coverage for the second group of devices.

11. The system of claim 10, the operations further comprising applying the second BLER target to the second group of devices for uplink BLER.

12. The system of claim 11, the operations further comprising applying the second BLER target to the second group of devices for both uplink BLER and downlink BLER.

13. The system of claim 10, wherein the first BLER target is between 8% and 12% and the second BLER target is between 1% and 3%.

14. The system of claim 10, further comprising transmitting information elements (IEs) for cell access for the RedCap devices.

15. The system of claim 14, the IEs comprising random access channel (RACH) and cell reselection IEs.

16. The system of claim 10, wherein the first group of devices includes enhanced mobile Broadband (eMBB) devices.

17. A method comprising:
providing a first block error rate (BLER) target for a first group of devices including enhanced mobile broadband (eMBB) devices;
providing a second BLER target for a second group of devices, wherein the second BLER target is lower than the first BLER target and the second group of devices includes reduced capability (RedCap) devices; and
applying the second BLER target to the second group of devices to extend coverage for the second group of devices.

18. The method of claim 17, further comprising providing information elements (IEs) comprising random access channel (RACH) and cell reselection IEs for the second group of devices.

19. The method of claim 17, further comprising applying the second BLER target to the second group of devices for at least uplink BLER.

20. The method of claim 17, wherein the first BLER target is between 8% and 12% and the second BLER target is between 1% and 3%.
